(19) United States
(12) Patent Application Publication
(10) Pub. No.: US 2006/0250912 A1
(43) Pub. Date: Nov. 9, 2006

(54) System and method for multi-laser optical medium

(76) Inventors: Thomas L. Pratt, Austin, TX (US); Christiaan Steenbergen, Austin, TX (US)

Correspondence Address: HAMILTON & TERRILE, LLP, P.O. BOX 203518, AUSTIN, TX, 78720, US

(21) Appl. No.: 11/124,747

(22) Filed: May 9, 2005

(51) Int. Cl. G11B 7/00

(52) U.S. Cl. 369/53.11

(57) ABSTRACT

An optical medium stores enabling information readable by a blue laser that enables the reading of content from the optical medium by a red laser. For instance, the enabling information is content protection information needed to decode the content, optical medium disc type information used to set the read parameters of the red laser or a key needed to read content. The enabling information is disposed in the optical medium to be readable by illumination of a blue laser but indistinguishable through illumination by the red laser. For instance, the enabling information is placed at the outer surface of an optical medium at which the focus point of the blue laser allows reading of marks while the red laser has insufficient precision to focus on individual marks. The marks may also be inked on the outer surface with a material that is reflective of blue light but that has inhibited reflectivity of red light. Alternatively, the enabling information is formed with pits sized to approximately one-half the wavelength of the red laser to reduce reflective energy by phase extinction.

### BACKGROUND OF THE INVENTION

1. Field of the Invention

The present invention relates in general to the field of information handling system optical storage media, and more particularly to a system and method for multi-laser optical medium.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

As information handling systems have grown more powerful over time, demand has increased for media to store greater quantities of information. Optical media have proven to be an effective portable storage media that is cost effective. Initially, infrared lasers were used to read and write Compact Disc (CD) optical media. Eventually, in an effort to store more information in a medium of a given size, red lasers were developed to read and write Digital Versatile Discs (DVD) media. Red lasers have a shorter wavelength than infrared lasers and thus interface with smaller-sized marks on a medium, allowing greater numbers of marks in a given area. Currently, in an effort to store even greater amounts of information in a given-sized medium, industry is developing blue laser based media. The shorter wavelength of the blue laser allows smaller-sized marks and more dense storage of information.

In order for a laser to read from an optical medium, the light from the laser is focused to illuminate the area in the medium where information is stored as marks having varying reflectivity. For CD media, the laser focuses through the thickness of the disc of approximately 1.2 mm to reach marks at the rear of the disc while DVD media have the marks half-way through the thickness of the disc at approximately 0.6 mm. One proposal for blue laser media, known as the Blu-ray standard, places the marks near the front surface of the disc so that the laser focuses at approximately 0.1 mm into the disc. For each type of laser, adjustments are made to account for the effects of disc material on the focus point of the laser. Overall, the placement of the blue laser marks near the front surface of the disc allows a greater density of marks compared with placement of the marks as greater depths by having a smaller laser focus point.

The Blu-ray standard may include red laser readable discs (BD9 discs) as well as blue laser readable discs (BD25 and BD50 discs). DVD density BD9 media may have lower manufacturing costs by extending DVD technology to read discs with a red laser. However, potential confusion may arise with users if optical drives are labeled as Blu-ray compliant but include only a red laser for reading BD9 discs. Such Blu-ray compliant drives would not be capable of interacting with blue laser media. The Blu-ray standards body may have considerable difficulty enforcing a requirement to include both blue and red lasers in optical drives.

### SUMMARY OF THE INVENTION

Therefore a need has arisen for a system and method which requires the use of a first laser type on an optical medium having information stored for access by a second laser type.

In accordance with the present invention, a system and method are provided which substantially reduce the disadvantages and problems associated with previous methods and systems for reading information from an optical medium. Content is stored on first portion of an optical medium readable by a first laser. Enabling information stored in a second portion of the optical medium is read by a second laser and applied to read content information stored in the first portion of the optical medium with the first laser. Enabling information readable by the second laser but indistinguishable by the first laser ensures the inclusion of both lasers in an optical drive for the optical drive to be compatible with the optical medium.

More specifically, upon insertion of an optical medium in an information handling system optical drive, a read engine illuminates an enabling information portion of the optical medium with a blue laser to read enabling information, such as content protection information, optical disc type information or a key to access the content information. The read engine applies the enabling information to enable the reading of content information from a content portion of the optical medium with a red laser. For instance, the blue laser reads information containing a required “key” which unlocks or enables reading the content portion of the optical medium with the red laser. Alternatively, the blue laser reads content protection information needed to decode content and applies the content protection information to decode information read from the content portion of the optical medium with the red laser. The enabling information is stored in a format readable by the blue laser but not distinguishable by the red laser. For instance, the enabling information is stored at the front surface of the optical medium or slightly into the depth of the optical medium, such as approximately at the focus point of the blue laser, around 0.1 mm into the thickness of the medium. The red laser focus at the front surface is insufficiently precise to read the enabling information. The content information is stored midway through the thickness of the optical medium, around 0.6 mm into the thickness of the medium, substantially at the focus point of the red laser, and thus is readable by the red laser.

The present invention provides a number of important technical advantages. One example of an important technical advantage is that optical drives that support blue laser standard operations using a red laser will include both the blue and red lasers. Users are thus less likely to face confusion by the availability of blue laser format optical drives that lack blue laser capability. Further, by storing enabling information readable by a blue laser to establish red laser read parameters, the optical disc is able to more quickly identify an optical disc type and set up to read content from the optical disc. For instance, the blue laser initiates the read of enabling information for both blue and red laser types of optical media rather than having to step from blue to red laser reads of enabling information.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system having a multi-laser optical medium; and

FIG. 2 depicts a side cutaway view of a multi-laser optical medium.

### DETAILED DESCRIPTION

Support for both blue and red laser operations in an information handling system optical drive is enforced by disposing enabling information readable only by a blue laser on an optical medium having content readable only by a red laser. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

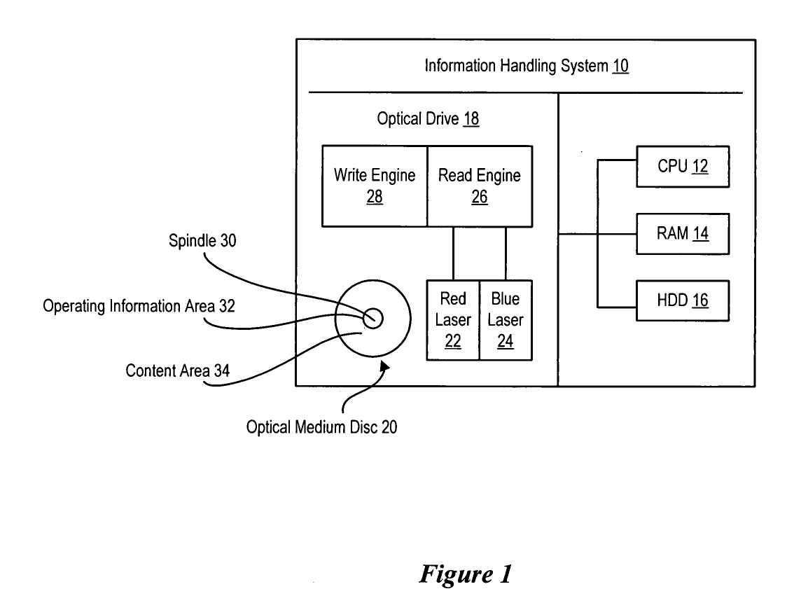

Referring now to FIG. 1, a block diagram depicts an information handling system 10 having a multi-laser optical medium. Information handling system 10 has processing components that process information, such as a CPU 12, RAM 14 and hard disk drive 16. The processing components interface with an optical drive 18 to communicate information for writing to an optical medium 20 and/or to receive information read from optical medium 20. Optical drive 18 has a red laser 22 and a blue laser 24, each operable to illuminate optical medium 20 to write information or to read information by changes in the reflectivity of optical medium 20 as it moves relative to the laser. A read engine 26 coordinates settings for lasers 22 and 24 to illuminate and read information from optical medium disc 20, such as by reading disc type information for optical medium 20 and selecting read parameters associated with the disc type. An optional write engine 28 coordinates settings for lasers 22 and 24 to illuminate optical medium 20 so as to alter the reflective qualities to record information.

Upon initial insertion of optical medium 20 into optical drive 18 the optical medium is spun about spindle 30 and blue laser 24 is positioned at the inner circumference to read enabling information from an enabling information area. Read engine 26 applies the enabling information to enable red laser 22 to read content from a content area 34 of optical medium 20. For example, the enabling information is content protection information needed to decode the content stored in content area 34, such as is used to protect commercially sold DVD movies. Alternatively, the enabling information is a “key” which unlocks or enables reading of the content portion. As another example, the enabling information is optical medium type identification information that enables read engine 26 to configure laser 22 or 24 to illuminate optical medium 20 and read the content. Identifying both red and blue laser parameters readable by a blue laser reduces the time needed for read engine 26 to identify the optical medium type since both types of optical media are identified by illumination of one type of laser. Enabling information is stored in enabling information area 32 so as to be indistinguishable by red laser 20. Thus, a blue laser is required to enable reading of content stored with a red laser format.

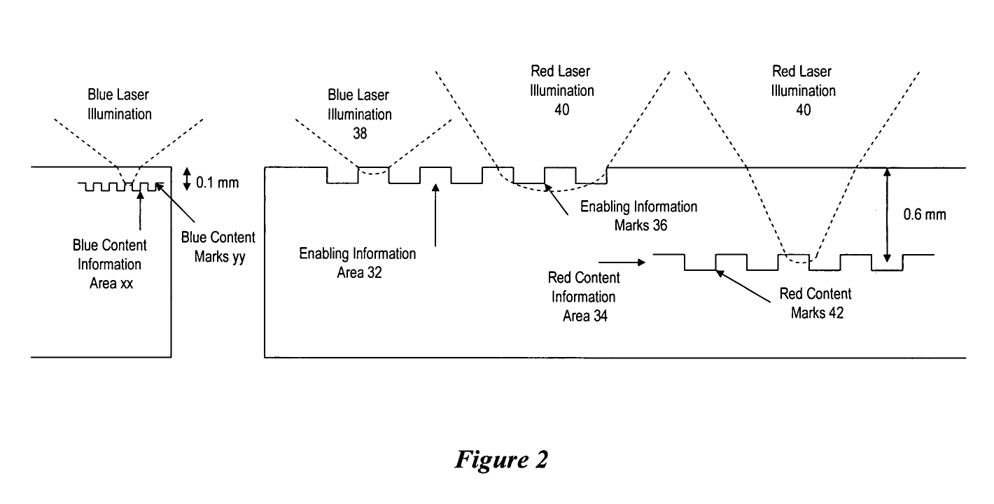

Referring now to FIG. 2, a side cutaway view of a multi-laser optical medium depicts information stored to be readable by a red laser or a blue laser. One technique to make enabling information readable by a blue laser but indistinguishable to a red laser is to adjust the depth and size of enabling information marks 36 at the media surface relative to focused blue laser illumination 38 and red laser illumination 40. Blue laser illumination 38 using Blu-ray Disc type optics focused at the surface of optical medium 20 produces a spot less than 2 micrometers wide while red laser illumination 40 using DVD-type optics focused at the surface of optical medium 20 will produce a spot approximately 5 micrometers wide. By placing enabling information marks 36 at the surface of optical medium 20 and sizing marks 36 to approximately the size used for CD marks (about 2 micrometers), blue laser illumination 38 is able to distinguish individual marks on the surface of optical medium 20 while red laser illumination cannot since it is unable to resolve the individual marks. Content marks 42 formed in content information area 34 are located at the focus point of red laser illumination 40, approximately 0.6 mm depth in the thickness of optical medium 20, and have standardized dimensions to allow reading of content by red laser 22. Since the enabling information is needed to read the content, both a blue and red laser are needed to read the content.

Three different techniques may be used separately or in combination so that enabling information is readable by a blue laser but indistinguishable by a red laser: manipulation of the size and dimensions of the marks; the use of marks having selected reflectivity; and the use of pits having a specific depth. The size, depth and dimensions of enabling information marks 36 are adjustable to make the enabling information indistinguishable by the red laser using DVD optics but distinguishable by the blue laser using Blu-ray optics at the surface of optical medium 20. For instance, the spot size focused at a disc front surface of a red laser optimized for use at a depth of 0.6 mm is approximately 5 micrometers so that marks sized under 2.5 micrometers are indistinguishable. For the blue laser, marks as small as 1.6 micrometers are distinguishable at a disc front surface. Thus, enabling information mark dimensions of less than 2.5 micrometers but greater than 1.6 micrometers will make the marks indistinguishable to a red laser but distinguishable by a blue laser. In alternative embodiments, the enabling information marks may reside at varying depths with the size varied accordingly to allow reading of the marks by a blue laser but not by a red laser. Reflectivity is managed by manipulating the material that makes the marks to reflect blue light but not red light. For instance, the marks are inked on the surface of optical medium 20 with a color that reflects blue light but absorbs red light. Phase extinction can minimize the reflection of red light from the enabling information marks 36. The marks are formed as pits 44 having a depth where red light reflects from the base of the pit 180 degrees out of phase with light reflected from the top, causing extinction. This depth equal to one-quarter of the red wavelength will not cause extinction for blue light. In fact, reflection will be close to maximum for blue. Phase extinction generally occurs at a depth that is a factor of one-half of the wavelength of the light. Enabling information marks 36 may have an increased width to ensure their readability by the blue laser in the absence of tracking information to align the blue laser.

Although the present invention has been described in detail, it should be understood that various changes, substitutions and alterations can be made hereto without departing from the spirit and scope of the invention as defined by the appended claims.

What is claimed is:

1. An optical medium comprising:
a material formed as a disc having a thickness and a spindle opening;
a data layer disposed in the material at a first depth in the thickness, the data layer having marks representing content information, the marks sized for individual illumination by a first laser focused through the thickness at the first depth; and
enabling information disposed in the material at a second depth in the thickness, the enabling information represented by marks sized for individual illumination by a second laser focused through the thickness at the second depth, the enabling information marks not distinguishable by the first laser focused through the thickness at the second depth.

2. The optical medium of claim 1 wherein the enabling information comprises content protection information associated with protection of content stored in the data layer.

3. The optical medium of claim 1 wherein the enabling information comprises identification of the optical medium type for setting laser read parameters.

4. The optical medium of claim 1 wherein the enabling information comprises identification of the optical medium type for setting write parameters.

5. The optical medium of claim 1 wherein the enabling information comprises a key to read content stored in the data layer.

6. The optical medium of claim 1 wherein the first laser comprises a red laser and the second laser comprises a blue laser.

7. The optical medium of claim 1 wherein the enabling information marks have a width sufficient for reading by the second laser without tracking.

8. The optical medium of claim 1 wherein the first depth comprises 0.6 mm and the second depth comprises 0.1 mm.

9. The optical medium of claim 1 wherein the marks comprise pits having a depth, the enabling information pits having a depth of approximately one-half the wavelength of the first laser to enhance phase extinction of light reflected by the first laser from the enabling information pits.

10. The optical medium of claim 1 wherein the second depth comprises marks at the surface of the optical medium.

11. The optical medium of claim 1 wherein the enabling information is marked with a material having reduced reflectivity of light from the first laser.

12. A method for reading information from an optical medium, the method comprising:
illuminating a first portion of the optical medium with a blue laser to read enabling information; and
applying the enabling information to illuminate a second portion of the optical medium with a red laser to read content information, the content information inaccessible without the enabling information.

13. The method of claim 12 further comprising:
forming the enabling information on the optical medium in a format unreadable by the red laser.

14. The method of claim 13 wherein forming the enabling information further comprises forming marks having a dimension individually distinguishable by the blue laser but not the red laser.

15. The method of claim 13 wherein forming the enabling information further comprises forming pits having a depth that enhances phase extinction of red laser light.

16. The method of claim 13 wherein forming the enabling information further comprises forming marks at a depth proximate the focus point of the blue laser and distal the focus point of the red laser.

17. The method of claim 16 wherein the depth of the enabling information is substantially at the outer surface of the optical medium.

18. The method of claim 13 wherein forming enabling information further comprises forming marks with a material having reduced reflectivity of red light.

19. The method of claim 12 wherein the enabling information comprises content protection information needed to decode the content information.

20. The method of claim 12 wherein the enabling information comprises optical medium disc type identification.

21. The method of claim 12 wherein the enabling information comprises a key to access the content information.

22. An information handling system comprising:
plural processing components operable to process information;
an optical drive interfaced with the processing components and operable to communicate information read from an optical medium to the processing components, the optical drive having a blue laser and a red laser; and
a read engine associated with the optical drive, the read engine operable to illuminate a first portion of the optical medium with a blue laser to read enabling information and to apply the enabling information to illuminate a second portion of the optical medium with a red laser to read content information.

23. The information handling system of claim 22 wherein the enabling information comprises content protection information needed to decode the content information.

24. The information handling system of claim 23 wherein the content information comprises a commercially sold video.

25. The information handling system of claim 22 wherein the enabling information comprises optical medium disc type identification.

26. The information handing system of claim 22 wherein the blue laser focuses at a predetermined depth to read the enabling information, the enabling information indistinguishable to the red laser at the predetermined depth.

27. The information handling system of claim 26 wherein the predetermined depth is substantially at the outer surface of the optical medium.

28. The information handling system of claim 27 wherein the enabling information comprises marks inked on the outer surface of the optical medium, the ink having inhibited reflectivity of red light.

29. The information handling system of claim 21 wherein the blue laser reads the enabling information without tracking information.

30. The information handling system of claim 21 wherein the enabling information comprises a key to access content information.
